(19) United States
(12) Patent Application Publication
(10) Pub. No.: US 2026/0246056 A1
(43) Pub. Date: Aug. 20, 2026

(54) HOUSING DEVICE, ENERGY STORAGE SYSTEM, MOTOR VEHICLE, AND MANUFACTURING METHOD FOR AN ENERGY STORAGE SYSTEM

(71) Applicant: HELLA GmbH & Co. KGaA, Lippstadt (DE)

(72) Inventors: Bastian BLOEMEKE, Diemelstadt (DE); Niklas NELLEN, Unna (DE); Sonja OTHOLT, Erwitte (DE)

(73) Assignee: HELLA GmbH & Co. KGaA, Lippstadt (DE)

(21) Appl. No.: 19/545,516

(22) Filed: Feb. 20, 2026

(30) Foreign Application Priority Data
Feb. 20, 2025 (DE) 10 2025 106 498.9

(51) Int. Cl. H01M 50/249; H01M 50/204; H01M 50/233

(52) U.S. Cl. CPC H01M 50/249; H01M 50/204; H01M 50/233

(57) ABSTRACT

A housing device for receiving cell devices for storing electrical energy for a motor vehicle. Further, the invention relates to an energy storage system comprising at least one housing device and at least one cell device, a motor vehicle with an energy storage system, and a manufacturing method for manufacturing an energy storage system.

This nonprovisional application claims priority under 35 U.S.C. § 119(a) to German Patent Application No. 10 2025 106 498.9, which was filed in Germany on February 20, 2025, and which is herein incorporated by reference.

### BACKGROUND OF THE INVENTION

### Field of the Invention

The present invention relates to a housing device for receiving cell devices. Further, the invention relates to an energy storage system comprising at least one housing device and at least one cell device, to a motor vehicle with an energy storage system, and to a manufacturing method for manufacturing an energy storage system.

### Description of the Background Art

In the current publicly known housing devices for receiving cell devices in the prior art, the cell devices are clamped in a separate, fixed frame to compensate for cell expansion, for example, against reversible expansion during charging and discharging and/or against continuous expansion due to aging of the cell devices. The known frames are often designed as a sheet-metal cage and/or as a compression of the cell devices between aluminum die-cast parts or extruded profiles.

The cell devices are usually preloaded with a certain pressure and exert high forces on the supporting and/or frame structure during operation. The supporting and/or frame structure is therefore usually designed to be very rigid and/or stable, which usually results in increased material, weight, cost, and/or component expenditure.

A disadvantage of the known solutions is that the cell devices are usually installed within a rigid support frame, for example, with metal elements, which, due to the base material, entail a high weight and are additionally connected to one another in multiple assembly steps. Due to the electrical conductivity of the metals, additional effort is required to ensure insulation of the cell devices, for example, by wrapping the lithium-ion cells with film and/or by gluing insulation film onto the metal elements.

### SUMMARY OF THE INVENTION

It is therefore an object of the present invention to overcome or to at least partially overcome the disadvantages described above in the prior art. In particular, it is an object of the invention to provide a housing device which makes it particularly easy to receive cell devices. In particular, it is further the object of the invention to provide an energy storage system, a motor vehicle, and a manufacturing method.

In this regard, features described in relation to the housing device of the invention also apply, of course, in relation to the energy storage system of the invention, to the motor vehicle of the invention, and to the manufacturing method of the invention, and conversely in each case, so that with regard to the disclosure, reference is or can always be made mutually to the individual aspects of the invention.

According to a first aspect of the invention, the object is achieved by a housing device for receiving cell devices for storing electrical energy for a motor vehicle, the housing device having a base body and a receiving volume for receiving the cell devices at least in sections within the base body, wherein the base body comprises at least one inner side, facing the receiving volume, and at least one outer side, facing away from the receiving volume, wherein the base body has, on the at least one outer side, at least two opposing primary rib devices for structurally reinforcing the housing device, wherein the base body has, on the at least one inner side, at least one tool recess for each of the at least two opposing primary rib devices, wherein the at least two tool recesses are designed for the engagement of a tool for jointly inserting the cell devices into the receiving volume, wherein the base body, the at least two opposing primary rib devices, and the at least two tool recesses are formed integrally.

The base body can preferably be made of plastic. The housing device advantageously enables a very rigid housing for receiving the cell devices. The advantageous structural properties of the housing device are primarily made possible by the external ribbing in the form of at least two opposing primary rib devices. In addition to the structurally advantageous properties, the rib devices further enable good material distribution for the fabrication of the housing device, for example, in an injection molding tool. As set forth in detail below, the rib devices are formed in and/or along a pressing direction of the cell devices on the housing device.

The housing device shapes the receiving volume by means of the base body. The base body is preferably formed in the shape of a container. The base body is preferably designed to be open only in one spatial direction and to be closed and/or sealed in the other five spatial directions. Described by way of illustration and example, the base body is configured, in an installed position, to be only open upward for receiving the cell devices. The base body has an inner side and an outer side. The inner side faces the receiving volume, the outer side faces away from the receiving volume. Preferably, the base body has exactly one receiving volume and/or just not multiple receiving volumes.

The at least two opposing primary rib devices enable a structural strengthening of the base body. Within the scope of the invention, the structural reinforcement of the base body by the at least two opposing primary rib devices is to be understood as a structural reinforcement of the base body against the expansion forces of the cell devices and/or for tensioning the cell devices in the receiving volume. The at least two opposing primary rib devices are formed on the outer side of the base body and integrally with the base body. Within the scope of the invention, the one-piece design of at least two devices is preferably to be understood as an integral, monolithic, and/or materially bonded connection of the at least two devices. The at least two opposing primary rib devices enable the housing device to absorb and/or withstand the stresses and/or elongation forces of the cell devices.

The at least two opposing primary rib devices can be arranged and/or formed on two opposing outer sides of the housing device. The at least two opposing primary rib devices preferably extend over at least 50%, at least 60%, at least 70%, at least 80%, or at least 90% of the respective surface of the base body, in particular of a wall of the base body and/or of the outer side of the base body.

The at least two opposing primary rib devices can be to be distinguished from a simple structuring and/or reinforcement of the wall thickness of the base body and/or the outer wall. The at least two opposing primary rib devices preferably enable a structural stabilization of the base body and not merely stabilization of the corresponding wall section of the base body. Preferably, the at least two opposing primary rib devices are configured, designed, and/or constructed to withstand both tensile and compressive forces.

Insertion of the cell devices into the housing device can be made possible by the at least two tool recesses of the invention. The cell devices are compressed by a tool before insertion and inserted into the receiving volume in the compressed state. When the tool is retracted, the cell devices expand again and create a press fit and/or a frictional connection between the cell devices in the receiving volume and the base body of the housing device. The tool can advantageously move in and out of the base body by the at least two tool recesses of the invention. The at least two tool recesses are preferably arranged on the at least one inner side for each of the at least two opposing primary rib devices. Preferably, multiple tool recesses are provided and arranged per side in order to enable uniform and/or gentle compression of the cell devices. Preferably, the tool does not spread the base body of the housing device by insertion of the cell devices. The insertion of the cell devices is preferably made possible by the compression of the cell devices. Within the scope of the invention, the compression of the cell devices is preferably to be understood as a compression of intercell material, for example, foam mats between the cell devices. The cell devices preferably comprise surface spring devices between the cell devices, for example, in the form of the preceding intercell material, to enable compression of the cell devices. The at least two tool recesses are preferably to be understood as material recesses of the base body. The at least two tool recesses are preferably made together with the receiving volume and/or form a common volume. The base body, the at least two opposing primary rib devices, and the at least two tool recesses are formed integrally, monolithically, and/or materially bonded. The base body is preferably made in a single casting and is therefore particularly advantageous to manufacture.

The cell devices can be understood as individual cell devices and/or as cell modules. The cell devices are preferably embodied as rechargeable cell devices. The cell devices are preferably connected in series, for example, to provide an operating voltage of 400 V.

A housing device designed in accordance with the invention is particularly advantageous because receiving of cell devices for storing electrical energy for a motor vehicle is made possible particularly easily, in particular wherein tensioning of the cell devices as well as reliable stability of the housing device is advantageously ensured.

The housing device can comprise a stacking direction for stacking the cell devices to be received, wherein the at least two primary rib devices are formed by the base body opposite one another along the stacking direction. The cell devices have a stacking direction in which the cell devices are arranged and stacked next to one another. The stacking direction preferably corresponds to a main expansion direction of the cell devices, so that tensioning of the cell devices in the stacking direction is advantageous for the operation of the cell devices. By way of an example and illustration, the cell devices are designed as cuboid cell blocks that are arranged next to one another along a long side. Preferably, the cell devices have a main extension plane. The cell devices extend primarily in the two directions of the main extension plane and have a smaller extent in the third spatial axis than in the first two spatial axes. The stacking direction is preferably designed orthogonal to the main extension plane of the cell devices. The structural reinforcement of the base body by the at least two opposing primary rib devices is particularly advantageous along the stacking direction, because tensioning of the cell device and/or counteracting the expansion forces of the cell devices are reliably and efficiently enabled by the housing device. A housing device designed in this way is particularly advantageous, because it makes it particularly easy to receive cell devices for storing electrical energy for a motor vehicle, in particular wherein tensioning of the cell devices as well as reliable stability of the housing device is advantageously ensured.

It can be provided in the case of a housing device that the base body comprises, on the inner side, at least two opposing cell contact surfaces, wherein the at least two opposing cell contact surfaces are formed free or substantially free of draft angles and/or that the housing device comprises a contact surface plate. The wording "X or substantially X" should be understood within the scope of the invention as a possible, slight deviation, for example, due to manufacturing tolerances or material and/or process properties, without changing the underlying, intended function of the feature. The cell contact surfaces are to be understood as the contacting surfaces of the housing device. The cell contact surfaces are each formed on at least one inner side for each of at least two opposing primary rib devices. The cell contact surfaces are embodied as continuous surfaces or as multiple individual surfaces. Preferably, the cell contact surfaces surround the at least two tool recesses at least in sections and/or are formed adjacent to the at least two tool recesses. The cell contact surfaces are preferably formed to be integral, materially bonded, and/or monolithic with the base body. The cell contact surfaces preferably enable the cell device to be pressed into the receiving volume.

The draft-angle-free configuration of the at least two opposing cell contact surfaces can be understood in such a way that the at least two opposing cell contact surfaces comprise no or substantially no draft angles for easier removal from a manufacturing tool. Of course, small radii are practically unavoidable, for example, at a transition between the at least two opposing cell contact surfaces and, for example, a bottom section of the base body and/or a wall section of the base body. However, the core of the feature is to be understood in such a way that the at least two opposing cell contact surfaces have a contact surface that is as flat as possible in relation to the cell devices, in particular wherein the at least two opposing cell contact surfaces are formed parallel to each other and/or orthogonal to a bottom section of the base body. The cell contact surfaces are preferably orthogonal to the stacking direction.

The contact surface plate can represent a separate, plate-shaped intermediate layer between the base body and the cell devices. The contact surface plate is preferably to be understood as a flat plate for uniform pressure distribution from the housing device to the cell devices. Preferably, the housing device comprises two contact surface plates which are arranged opposite each other on the cell devices. Some types of cell devices, for example, lithium-ion cells, require a small, even contact pressure when installed. In the "pouch cell" design, the interior of the cell device is only surrounded by a multiple layer of film, because of which the cell device could react more sensitively to uneven pressure and/or interruption of the contact surface of the housing device when installed, for example, in the form of accelerated aging. For example, the cell contact surfaces are interrupted by the at least two tool recesses and/or have interruptions and/or unevenness due to the manufacturing process, which makes a uniform contact pressure to the cell devices difficult. The at least one contact surface plate enables bridging of the at least two tool recesses and/or uniform pressure distribution from the base body to the cell devices. The at least one contact surface plate is preferably designed to be removable from the receiving volume. The at least one contact surface plate is particularly preferably centered by the centering devices described below. The contact surface plate is not necessary for cell devices that are surrounded by an outer sheet metal layer and/or a sheet metal sleeve, for example. Small interruptions in the contact surface of the base body, such as, for example, the at least two tool recesses, can be compensated for by the sheet metal layer and/or the sheet metal sleeve.

A housing device designed in this way is particularly advantageous, because it makes it particularly easy to receive cell devices for storing electrical energy for a motor vehicle, in particular wherein tensioning of the cell devices as well as reliable stability of the housing device is advantageously ensured by the at least two opposing cell contact surfaces.

A base body can be formed to be rectangular in shape and/or comprises at least four wall sections, a bottom section, and an open cover interface, in particular wherein the at least two opposing primary rib devices are formed by two opposing wall sections. The base body shapes the intake volume. The base body is preferably formed in the shape of a container. Preferably, the base body and/or the receiving volume are designed to be rectangular or substantially rectangular. The base body preferably comprises four wall sections and a bottom section that surround the holding volume. The base body is preferably designed to be open upward in an installation position and/or has a cover interface for connecting a separate cover device. The cover device is not intended to be the subject of the present application. The cover interface is preferably formed by the upper end faces of the four wall sections. The four wall sections and the bottom section are preferably formed integrally, monolithically, and/or materially bonded to one another. The four wall sections and the bottom section are preferably connected to one another in a fluid-tight manner and/or manufactured in a single casting. A housing device designed in this way is particularly advantageous, because it makes it particularly easy to receive cell devices for storing electrical energy for a motor vehicle, in particular wherein tensioning of the cell devices as well as reliable stability of the housing device is advantageously ensured by the design of the base body.

A base body can have a wall thickness and the at least two opposing primary rib devices have a depth, wherein the depth in relation to the wall thickness has a factor of at least 3, preferably at least 5, at least 7, or at least 10. The at least two opposing primary rib devices are designed to structurally reinforce the housing device. The structural reinforcement of the housing device is advantageously made possible, for example, if the at least two opposing primary rib devices have a depth, wherein the depth in relation to the wall thickness has a factor of at least 3, preferably at least 5, at least 7, or at least 10. Within the scope of the invention, the wall thickness is preferably to be understood as the wall thickness of the base body. The wall thickness is preferably to be understood as the average wall thickness of the base body and/or as the wall thickness of the wall section of the base body on which the respective primary rib device is formed. The depth of the primary rib devices is understood to be preferably orthogonal to the respective wall section. Preferably, the depth of the primary rib devices is understood to be along the stacking direction of the base body. By way of illustration and example, a wall thickness of 5 mm is selected for the base body. In the example, the depth of the at least two opposing primary rib devices is 2 cm. The depth of the at least two opposing primary rib devices is preferably adapted to the cell devices and/or their compression. A higher pressing force for the cell devices preferably requires a more stable and thus deeper design of the at least two opposing primary rib devices. Alternatively or in addition, the depth of the at least two opposing primary rib devices in each case in relation to a thickness of a cell device corresponds to a factor of 0.8 to 1.5, in particular 0.9 to 1.2. A housing device designed in this way is particularly advantageous, because it makes it particularly easy to receive cell devices for storing electrical energy for a motor vehicle, in particular wherein tensioning of the cell devices as well as reliable stability of the housing device is advantageously ensured by the design of the at least two opposing primary rib devices.

The housing device can have, on the at least one inner side, at least two opposing centering devices for centering the cell devices in the receiving volume, in particular orthogonal to the stacking direction. The at least two centering devices are designed to center the cell devices in the receiving volume. The centering of the cell devices by the at least two centering devices occurs orthogonally to the stacking direction, parallel to the cell contact surfaces, parallel to the at least two opposing primary rib devices, and/or along a main extension plane of the cell devices. The at least two centering devices are designed, for example, as conical projections on the inner wall of the base body, so that an increasing centering occurs when the cell devices are inserted. The at least two centering devices are preferably designed across the entire width of the receiving volume or substantially across the entire width of the receiving volume. The at least two centering devices are preferably formed to be integral, materially bonded, and/or monolithic with the base body. A housing device designed in this way is particularly advantageous, because it makes it particularly easy to receive cell devices for storing electrical energy for a motor vehicle, in particular wherein tensioning of the cell devices as well as reliable stability of the housing device is advantageously ensured by the design of the at least two centering devices.

The at least two tool recesses can each be arranged opposite one of the at least two opposing primary rib devices on the at least one inner side. The at least two tool recesses are preferably arranged on the at least one inner side for each of the at least two opposing primary rib devices. The at least two tool recesses are preferably formed as engagement portions for a tool for inserting and/or removing the cell devices. Preferably, multiple tool recesses are provided and arranged per side in order to enable uniform and/or gentle compression of the cell devices. Preferably, the tool recesses are centered in the base body and/or evenly spaced from one another. Preferably, the at least two tool recesses are centered relative to the at least two opposing primary rib devices. Preferably, the at least two tool recesses on the other side of the wall thickness of the base body protrude at least in sections into the at least two opposing primary rib devices. A housing device designed in this way is particularly advantageous, because it makes it particularly easy to receive cell devices for storing electrical energy for a motor vehicle, in particular wherein tensioning of the cell devices as well as reliable stability of the housing device is advantageously ensured by the design of the at least two tool recesses.

The base body can comprise at least one secondary rib device, wherein the secondary rib device is designed to be flatter than the primary rib devices. Within the scope of the invention, the at least two opposing primary rib devices are to be distinguished from a secondary rib device. The at least two opposing primary rib devices preferably enable a structural stabilization of the base body and not merely stabilization of the corresponding wall section of the base body. Preferably, the at least two opposing primary rib devices are configured, designed, and/or constructed to withstand both tensile and compressive forces. The secondary rib devices are to be understood as a structure on, for example, a wall section of the base body for stabilizing the wall section. The secondary rib devices enable advantageous material savings and/or an increase in the stability of a wall section and/or the base body. The secondary rib devices are flatter, less deep, and/or less voluminous in relation to the primary rib devices. The secondary rib devices have a depth in relation to a wall thickness with a factor of only 0.5 to 1.5, for example. The secondary rib devices are preferably formed on the wall sections between the wall sections with the at least two opposing primary rib devices. The secondary rib devices are preferably formed on the wall sections along the stacking direction. The secondary rib devices are preferably formed to be integral, materially bonded, and/or monolithic with the base body. A housing device designed in this way is particularly advantageous, because it makes it particularly easy to receive cell devices for storing electrical energy for a motor vehicle, in particular wherein tensioning of the cell devices as well as reliable stability of the housing device is advantageously ensured by the at least two secondary rib devices.

The housing device, in particular the base body, can be manufactured by means of an injection molding process, in particular a MuCell process, and/or that the housing device, in particular the base body, comprises injected gas inclusions. The housing device, in particular a wall thickness and/or the amount of material used, can also be reduced if the housing device is manufactured at least in sections using the MuCell process. The MuCell process comprises, for example, foaming during injection molding and/or injecting gas and/or a gas mixture into the material of the base body during manufacturing. Preferably, the base body is made from a plastic using a MuCell injection molding process. A housing device designed in this way is particularly advantageous, because it makes it particularly easy to receive cell devices for storing electrical energy for a motor vehicle, in particular wherein tensioning of the cell devices as well as reliable stability of the housing device is advantageously ensured by the design and/or manufacturing of the base body.

The housing device can comprise at least one tensioning device, wherein the at least one tensioning device is arranged, at least in sections, circumferentially on the base body and/or that at least two tensioning devices are arranged opposite one another on the base body. The tensioning device enables a preferably additional structural reinforcement of the base body. The at least one tensioning device is designed, for example, as a metal strip, a fiber-reinforced strip, and/or another type of tensioning device. The tensioning device is preferably formed circumferentially on the base body or along two opposite sides of the base body. Preferably, the base body comprises two tensioning devices along two opposite wall sections of the base body along the stacking direction of the cell devices. The at least one tensioning device is preferably designed to be integrated into the base body, at least in sections. The at least one tensioning device is arranged, at least in sections, circumferentially on and/or in the base body. A housing device designed in this way is particularly advantageous, because it makes it particularly easy to receive cell devices for storing electrical energy for a motor vehicle, in particular wherein tensioning of the cell devices as well as reliable stability of the housing device is advantageously ensured by the at least one tensioning device.

The base body can comprise at least one foot device on the outer side for fastening and/or holding the housing device, in particular wherein the at least one foot device is formed, at least in sections, circumferentially on the outer side. The foot device by way of example is formed as a projection, in particular a circumferential projection, on the base body. The foot device advantageously enables a fastening and/or holding of the housing device within the motor vehicle and/or during assembly or disassembly of the cell devices. The foot device is preferably formed to be integral, materially bonded, and/or monolithic with the base body. A housing device designed in this way is particularly advantageous, because it makes it particularly easy to receive cell devices for storing electrical energy for a motor vehicle, in particular wherein tensioning of the cell devices as well as reliable stability of the housing device is advantageously ensured by the at least one foot device.

The at least two opposing primary rib devices can comprise at least two vertical ribs and/or at least two horizontal ribs. The primary rib devices are preferably formed with a large surface area over the respective wall section of the housing device. Preferably, a primary rib device comprises at least 50%, preferably at least 60%, at least 70%, or at least 80% of the respective wall section of the housing device. For advantageous structural reinforcement of the housing device, the primary rib devices each comprise at least two vertical ribs and/or at least two horizontal ribs. Preferably, the primary rib devices each comprise a plurality of vertical ribs and a plurality of horizontal ribs. A housing device designed in this way is particularly advantageous, because it makes it particularly easy to receive cell devices for storing electrical energy for a motor vehicle, in particular wherein tensioning of the cell devices as well as reliable stability of the housing device is advantageously ensured by the design of the at least two opposing primary rib devices.

According to a second aspect of the invention, the object is also achieved by an energy storage system comprising at least one housing device according to the first aspect and at least one cell device. The described energy storage system has all the advantages that have already been described for the housing device according to the first aspect of the invention.

According to a third aspect of the invention, the object is also achieved by a motor vehicle having at least one energy storage system according to the second aspect. The motor vehicle described has all the advantages that have already been described for the energy storage system according to the second aspect and/or for the housing device according to the first aspect of the invention. The energy storage system is preferably designed to supply a drive device of the motor vehicle with electrical energy.

According to a fourth aspect of the invention, the object is also achieved by a manufacturing method for manufacturing an energy storage system. The manufacturing method comprises: providing a housing device of the energy storage system for receiving at least two cell devices of the energy storage system for storing electrical energy for a motor vehicle, wherein the housing device comprises a base body and a receiving volume, compressing the at least two cell devices using a tool, inserting the at least two compressed cell devices into the receiving volume, and manufacturing the energy storage system by retracting the tool and thereby expanding the at least two cell devices in the housing device.

The energy storage system can be designed according to the second aspect. The manufacturing method described thus preferably results in all of the advantages that have already been described for the energy storage system according to the second aspect and/or for the housing device according to the first aspect of the invention.

The method steps described above and in the following, unless explicitly stated otherwise, can preferably be carried out individually, together, once, multiple times, temporally in parallel, and/or successively in any order. A designation as, for example, "first method step" and "second method step" does not imply any temporal order and/or prioritization. A preferred sequence of the method steps provides for the method steps to be carried out in the order listed.

The compression of the cell devices can be understood as a compression of intercell material, for example, foam mats between the cell devices. The cell devices preferably comprise surface spring devices between the cell devices, for example, in the form of the preceding intercell material, to enable compression of the cell devices.

The housing device provided can be manufactured using a MuCell process. The manufacturing method of the invention enables a very rigid energy storage system due to the primary rib devices of the housing device. The cell devices are compressed against each other using a tool to enable insertion of the cell devices into the receiving volume. The tool recesses in the base body enable movement of the tool into the base body to place the cell devices. The retraction of the tool and thereby the expansion of the at least two cell devices in the housing device creates an advantageous frictional and/or force-fit connection of the cell devices in the housing device.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a housing device with four cell devices in a perspective view;

FIG. 2 shows a housing device with three cell devices in a sectional side view;

FIG. 3 shows, in a functional view, a motor vehicle with an energy storage system with a housing device and three cell devices; and

FIG. 4 shows a manufacturing method in a flow chart.

### DETAILED DESCRIPTION

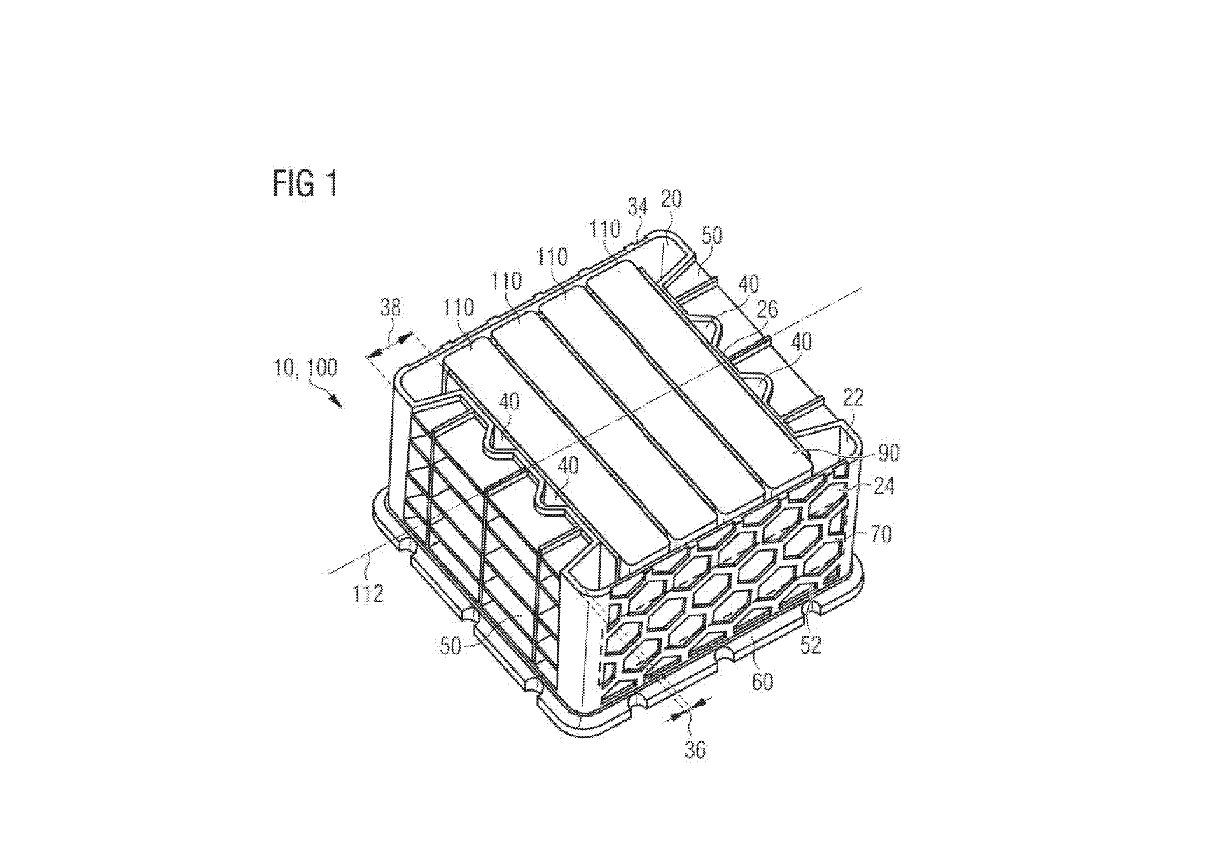

A housing device 10 with four cell devices 110 is shown schematically in a perspective view in FIG. 1. Housing device 10 with cell devices 110 forms an energy storage system 100. Housing device 10 has a base body 20 and a receiving volume 90 for receiving cell devices 110 within base body 20. Base body 20 comprises an inner side 22, facing receiving volume 90, and an outer side 24, facing away from receiving volume 90. Base body 20 has, on outer side 24, two opposing primary rib devices 50 for the structural reinforcement of housing device 10. Base body 20 has, on inner side 22, two tool recesses 40 for each of the opposing primary rib devices 50, wherein the four tool recesses 40 are configured for the engagement of a tool for jointly inserting cell devices 110 into receiving volume 90. Base body 20, the two opposing primary rib devices 50, and the four tool recesses 40 are formed integrally. Housing device 10 comprises a stacking direction 112 for stacking cell devices 110 to be received, wherein the two primary rib devices 50 are formed opposite each other along stacking direction 112 by base body 20. Base body 20 comprises, on inner side 22, three cell contact surfaces per side, therefore, a total of six opposing cell contact surfaces 26, wherein the six opposing cell contact surfaces 26 are designed to be free of draft angles. Base body 20 is formed to be rectangular in shape and comprises four wall sections 30, a bottom section 32, and an open cover interface 34. The two opposing primary rib devices 50 are formed by two opposing wall sections 30. Base body 20 has a wall thickness 36, and the two opposing primary rib devices 50 have a depth 38. Depth 38 has a factor of 9 in relation to wall thickness 36. The six tool recesses 40 are each arranged opposite one of the two opposing primary rib devices 50 on inner side 22. Base body 20 comprises two secondary rib devices 52 on the two wall sections 30 of base body 20 along stacking direction 112. Secondary rib devices 52 are flatter than primary rib devices 50. Housing device 10, in this case base body 20, is manufactured using an injection molding process, in this case a MuCell process, and comprises injected gas inclusions. Housing device 10 comprises two tensioning devices 70, wherein only one of these is indicated by a dashed line. Tensioning devices 70 are arranged opposite each other in base body 20, in this case on wall sections 30 along stacking direction 112. Base body 20 comprises a foot device 60 on outer side 24 for fastening and holding housing device 10. Foot device 60 is formed circumferentially on outer side 24. The two opposing primary rib devices 50 comprise three vertical ribs and four horizontal ribs.

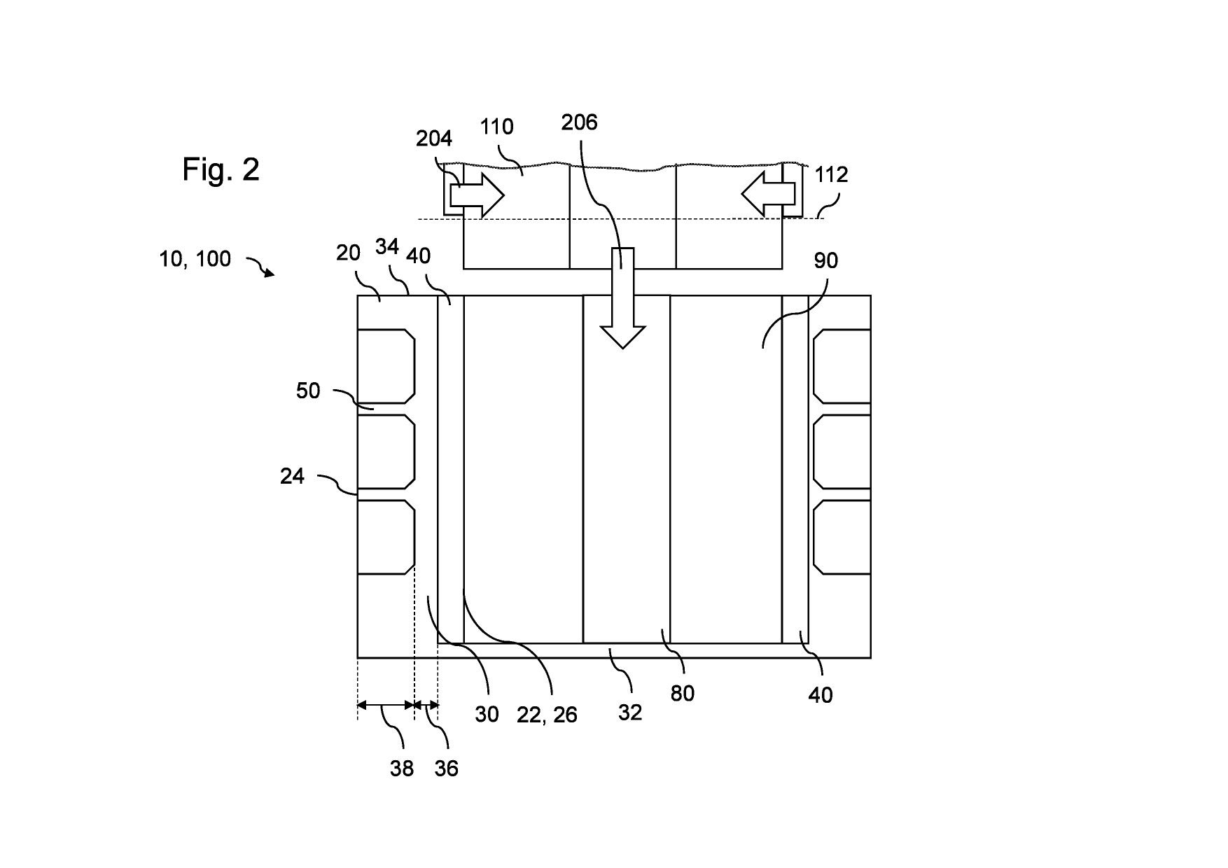

FIG. 2 schematically shows a sectional side view of a housing device 10 with three cell devices 110. Housing device 10 with cell devices 110 forms an energy storage system 100. Housing device 10 has a base body 20 and a receiving volume 90 for receiving cell devices 110 within base body 20. Base body 20 comprises an inner side 22, facing receiving volume 90, and an outer side 24, facing away from receiving volume 90. Base body 20 has, on outer side 24, two opposing primary rib devices 50 for the structural reinforcement of housing device 10. Base body 20 has, on inner side 22, two tool recesses 40 for each of the opposing primary rib devices 50, wherein the four tool recesses 40 are configured for the engagement of a tool for jointly inserting cell devices 110 into receiving volume 90. Base body 20, the two opposing primary rib devices 50, and the four tool recesses 40 are formed integrally. Housing device 10 comprises a stacking direction 112 for stacking cell devices 110 to be received, wherein the two primary rib devices 50 are formed opposite each other along stacking direction 112 by base body 20. Base body 20 comprises, on inner side 22, two opposing cell contact surfaces 26, wherein the two opposing cell contact surfaces 26 are designed to be free of draft angles. Base body 20 is formed to be rectangular in shape and comprises four wall sections 30, a bottom section 32, and an open cover interface 34. Base body 20 has a wall thickness 36, and the two opposing primary rib devices 50 have a depth 38. Depth 38 has a factor of 3 in relation to wall thickness 36. Housing device 10 has, on inner side 22, two opposing centering devices 80 for centering cell devices 110 in receiving volume 90, here orthogonal to stacking direction 112. Only one centering device 80 is shown in the sectional view. The method steps of compressing 204 and inserting 206 are indicated by arrows.

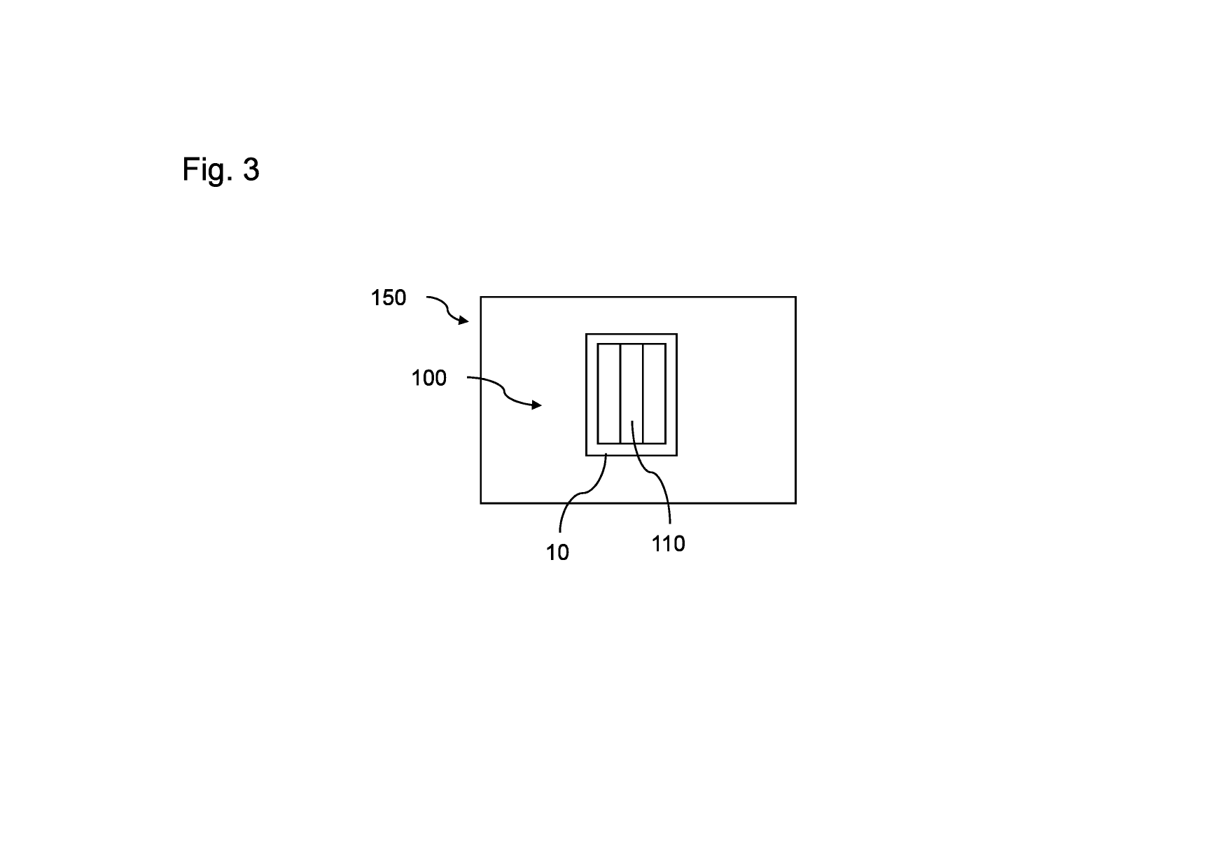

FIG. 3 schematically shows, in a functional a view, a motor vehicle 150 with an energy storage system 100 with a housing device 10 and three cell devices 110.

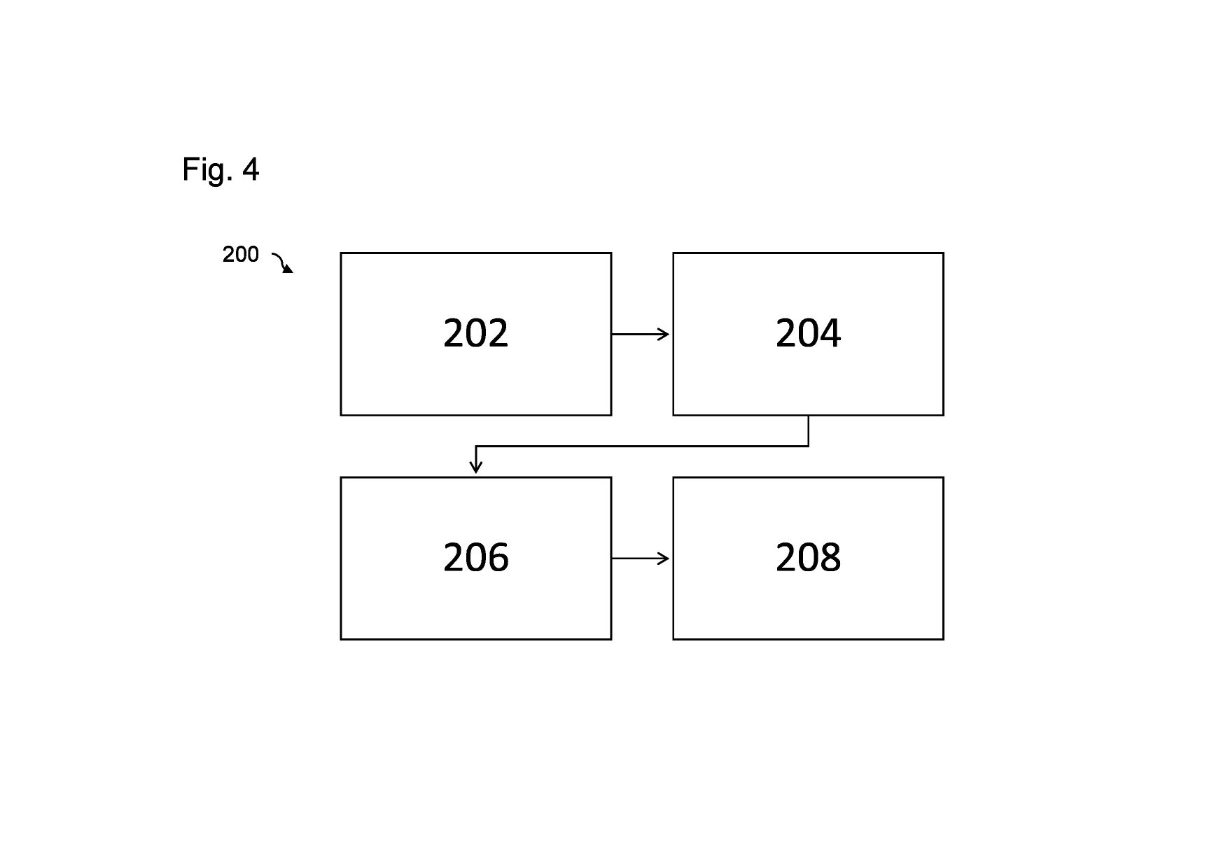

FIG. 4 schematically shows, in a flow diagram, an embodiment of the manufacturing method 200 according to the invention. For improved clarity, only the reference symbols of the method steps are shown in FIG. 4. In a first method step, manufacturing method 200 comprises providing 202 a housing device 10 of energy storage system 100 for receiving three cell devices 110 of the energy storage system for storing electrical energy for a motor vehicle 150, wherein the housing device 10 comprises a base body 20 and a receiving volume 90. In a further method step, manufacturing method 200 comprises compressing 204 the three cell devices 110 by a tool. In a further method step, manufacturing method 200 comprises inserting 206 the three compressed cell devices 110 into receiving volume 90. In a further method step, manufacturing method 200 comprises manufacturing 208 energy storage system 100 by retracting the tool and thereby expanding the three cell devices 110 in housing device 10.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A housing device for receiving at least two cell devices for storing electrical energy for a motor vehicle, the housing device comprising:
a base body; and
a receiving volume to receive the cell devices at least in sections within the base body,
wherein the base body comprises at least one inner side, facing the receiving volume, and at least one outer side, facing away from the receiving volume,
wherein the base body comprises, on the at least one outer side, at least two opposing primary rib devices for structurally reinforcing the housing device,
wherein the base body, on the at least one inner side, comprises at least one tool recess for each of the at least two opposing primary rib devices,
wherein the at least two tool recesses are designed for the engagement of a tool for jointly inserting the cell devices into the receiving volume, and
wherein the base body, the at least two opposing primary rib devices, and the at least two tool recesses are formed integrally.

2. The housing device according to claim 1, wherein the housing device comprises a stacking direction for stacking the cell devices to be received, and wherein the at least two primary rib devices are formed by the base body opposite each other along the stacking direction.

3. The housing device according to claim 1, wherein the base body comprises, on the inner side, at least two opposing cell contact surfaces, wherein the at least two opposing cell contact surfaces are formed to be free of draft angles, and/or wherein the housing device comprises a contact surface plate.

4. The housing device according to claim 1, wherein the base body is formed to be rectangular in shape and/or comprises at least four wall sections, a bottom section, and an open cover interface, or wherein the at least two opposing primary rib devices are formed by two opposing wall sections.

5. The housing device according to claim 1, wherein the base body has a wall thickness and the at least two opposing primary rib devices have a depth, wherein the depth in relation to the wall thickness has a factor of at least 3, at least 5, at least 7, or at least 10.

6. The housing device according to claim 1, wherein the housing device has, on the at least one inner side, at least two opposing centering devices for centering the cell devices in the receiving volume or orthogonal to the stacking direction.

7. The housing device according to claim 1, wherein the at least two tool recesses are each arranged opposite one of the at least two opposing primary rib devices on the at least one inner side.

8. The housing device according to claim 1, wherein the base body comprises at least one secondary rib device, and wherein the secondary rib device is designed to be flatter than the primary rib device.

9. The housing device according to claim 1, wherein the housing device or the base body is manufactured via an injection molding process or a MuCell process, and/or wherein the housing device and/or the base body comprises injected gas inclusions.

10. The housing device according to claim 1, wherein the housing device comprises at least one tensioning device, wherein the at least one tensioning device is arranged, at least in sections, circumferentially on the base body, and/or wherein at least two tensioning devices are arranged opposite one another on the base body.

11. The housing device according to claim 1, wherein the base body comprises, on the outer side, at least one foot device for fastening and/or holding the housing device, or wherein the at least one foot device is formed, at least in sections, circumferentially on the outer side.

12. The housing device according to claim 1, wherein the at least two opposing primary rib devices comprise at least two vertical ribs and/or at least two horizontal ribs.

13. An energy storage system comprising at least one housing device according to claim 1 and at least one cell device.

14. A motor vehicle comprising at least one energy storage system according to claim 13.

15. A manufacturing method for manufacturing an energy storage system according to claim 13, the manufacturing method comprising:
providing a housing device of the energy storage system for receiving at least two cell devices of the energy storage system for storing electrical energy for a motor vehicle, the housing device comprising a base body and a receiving volume;
compressing the at least two cell devices using a tool;
inserting the at least two compressed cell devices into the receiving volume; and
manufacturing the energy storage system by retracting the tool and thereby expanding the at least two cell devices in the housing device.
